(19) United States
(12) Patent Application Publication
(10) Pub. No.: US 2026/0039178 A1
(43) Pub. Date: Feb. 5, 2026

(54) LINEAR MOTOR

(71) Applicant: AAC Microtech (Changzhou) Co., Ltd., Changzhou City (CN)

(72) Inventor: Kaiqi Zhou, Changzhou (CN)

(21) Appl. No.: 18/988,958

(22) Filed: Dec. 20, 2024

Related U.S. Application Data
(63) Continuation of application No. PCT/CN2024/109825, filed on Aug. 5, 2024.

(51) Int. Cl. H02K 33/18; H02K 33/02

(52) U.S. Cl. CPC H02K 33/18; H02K 33/02; H02K 2203/03

(57) ABSTRACT

Provided is linear motor, including housing with receiving space, and vibrator assembly, stator assembly and elastic assembly received in receiving space. Elastic assembly is configured to suspend and support vibrator assembly in receiving space. Vibrator assembly includes central magnet portion. Stator assembly includes coil portion and auxiliary magnet portions arranged along first direction. Coil portion is sleeved on middle portion of outer periphery of central magnet portion, and two ends of central magnet portion are provided with auxiliary magnet portions, respectively. coil portion pushes vibrator assembly to vibrate along first direction after being energized, and auxiliary magnet portions and elastic assembly jointly provide restoring force for vibrator assembly, so that vibrator assembly reciprocates along first direction. Linear motor of present disclosure can enhance low-frequency vibration sensation, improve overall stability and reliability of motor, and effectively control production cost.

### TECHNICAL FIELD

The present disclosure relates to the field of motors and, in particular, to a linear vibration motor.

### BACKGROUND

With the development of motor technology, the vibration sensation of traditional X-axis linear motors in the high-frequency field can meet the needs of most customers, but the vibration sensation of traditional X-axis linear motors in the low-frequency field is not satisfactory, and there is still a certain gap between the performance of existing products and customer needs. At present, the minimum base frequency of X-axis linear motors that are maturely used in the field of mobile phones is about 130Hz. Under the same size, the improvement of low-frequency vibration has encountered a bottleneck. Optimizing the performance structure of traditional materials has limited improvement in low-frequency vibration and the cost is relatively high. However, the current market has a strong demand for low-frequency motors, such as wearable watches, mobile phones, handhelds, game controllers, and car seat cushions. The motors used in these fields usually require a base frequency of around 60-90Hz, which is lower than the frequency of the current mainstream linear motors. Faced with huge market demand, the low-frequency performance of existing motors still needs to be further improved.

Therefore, it is necessary to provide a linear motor that can effectively enhance low-frequency vibration sensation while balancing the cost and manufacturing process.

### SUMMARY

The purpose of the present disclosure is to provide a linear motor to solve the technical problem of poor low-frequency vibration sensation of linear motors in the related art.

The technical solutions of the present disclosure are as follows.

In a first aspect, the present disclosure provides a linear motor, including a housing with a receiving space, and a vibrator assembly, a stator assembly and an elastic assembly received in the receiving space. The elastic assembly is configured to suspend and support the vibrator assembly in the receiving space. The vibrator assembly includes a central magnet portion. The stator assembly includes a coil portion and auxiliary magnet portions arranged along a first direction. The coil portion is sleeved on a middle portion of an outer periphery of the central magnet portion, and two ends of the central magnet portion are provided with the auxiliary magnet portions, respectively. The coil portion, when energized, drives the vibrator assembly to vibrate along the first direction, and the auxiliary magnet portions and the elastic assembly jointly provide a restoring force for the vibrator assembly to reciprocate along the first direction.

One of the auxiliary magnet portions includes a first auxiliary magnet group and/or a second auxiliary magnet group. The first auxiliary magnet group includes two first auxiliary magnets arranged along a second direction and arranged on two sides of the end of the central magnet portion, respectively. The second auxiliary magnet group includes two second auxiliary magnet arranged along a third direction and arranged on two sides of the end of the central magnet portion, respectively. The first direction, the second direction and the third direction are arranged perpendicularly to each other.

As an improvement, the central magnet portion includes a first magnet, an iron core, and a second magnet arranged along the first direction, and the first magnet and the second magnet are symmetrically arranged on two sides of the iron core.

As an improvement, the first magnet and the second magnet are magnetized along the first direction and magnetic poles with same polarity are arranged opposite to each other.

As an improvement, the two first auxiliary magnets are magnetized along the second direction and magnetic poles with same polarity are arranged opposite to each other, the two second auxiliary magnets are magnetized along the third direction and magnetic poles with same polarity are arranged opposite to each other, and magnetic poles of a polarity of the first auxiliary magnet and the second auxiliary magnet are arranged opposite to magnetic pole of same polarity of the central magnet portion, respectively.

As an improvement, the vibrator assembly further includes weights fixed to both ends of the central magnet portion along the first direction, and each of the weights is connected to the elastic assembly, respectively.

As an improvement, the elastic assembly includes two elastic sheets arranged along the first direction. One of the elastic sheets is arranged between one end of the vibrator assembly and the housing, and the other of the elastic sheets is arranged between the other end of the vibrator assembly and the housing. The two elastic sheets are V-shaped structures, and opening ends of the two elastic sheets are arranged in opposite directions.

As an improvement, one of the elastic sheets includes an elastic arm, and a first connecting arm and a second connecting arm extending from the elastic arm, respectively. The first connecting arm is configured to connect to the vibrator assembly, and the second connecting arm is configured to connect to the housing. The elastic assembly further includes a first insert, a second insert and a third insert fixed to the elastic sheet and having overlapping projections along the first direction. The first insert is fixed to a side of the first connecting arm away from the vibrator assembly, the second insert is fixed to a side of the second connecting arm away from the housing, and the third insert is fixed to a side of the second connecting arm close to the housing.

As an improvement, the linear motor further includes a circuit board (PCB) at least partially received in the receiving space. The circuit board is electrically connected to the coil portion.

As an improvement, the linear motor further includes one or more central magnet portions. A number of the coil portions is equal to a number of the central magnet portions, and the coil portions are arranged in a one-to-one correspondence with the central magnet portions. In response to a fact that the linear motor comprises a plurality of the central magnet portions, the plurality of the central magnet portions is sequentially connected end-to-end along the first direction and fixed into a whole. One of the auxiliary magnet portions is arranged corresponding to a head end of a central magnet portion located at a head of the whole, one of the auxiliary magnet portions is arranged corresponding to a tail end of a central magnet portion located at a tail of the whole, and remaining auxiliary magnet portions correspond to connected ends of two adjacent central magnet portions.

The present disclosure has the following advantages: in the initial state, the magnetic circuit resulting force of the linear motor according to the present disclosure is zero, and the vibrator assembly maintains balance. In response to the fact that the coil portion is energized, the vibrator assembly can be pushed to vibrate along the first direction. The auxiliary magnet portions and the elastic assembly jointly provide a restoring force for the vibrator assembly, so that the vibrator assembly reciprocates along the first direction. The magnetic force generated by the interaction between the auxiliary magnet portions and the central magnet portion can increase the negative stiffness, thereby reducing the resonant frequency of the linear motor and improving the low-frequency vibration. Meanwhile, the auxiliary magnet portions do not affect the vibration path of the vibrator assembly and do not occupy the design dimensions of the first direction, thus the size of the linear motor will not be increased, and the attenuation of the electromagnetic driving force under a large stroke can be improved, in such a manner that the motor has a more stable input performance within the stroke. In addition, the process and thickness requirements for the elastic assembly can be relaxed to improve the overall stability and reliability of the motor. Moreover, the auxiliary magnet portions have a simple structure, are easy to process, and have a low cost, which can effectively control the production cost.

### BRIEF DESCRIPTION OF DRAWINGS

FIG. 1 is a structural schematic diagram of a linear motor according to an embodiment of the present disclosure.

FIG. 2 is an exploded view of the linear motor shown in FIG. 1.

FIG. 3 is a top view of the linear motor shown in FIG. 1.

FIG. 4 is a cross-sectional view taken along line A-A of FIG. 3.

FIG. 5 is a structural schematic diagram of the linear motor shown in FIG. 3 with a cover removed.

FIG. 6 is a structural schematic diagram of the linear motor shown in FIG. 5 from another perspective.

FIG. 7 is a schematic diagram of a magnetic circuit of the linear motor shown in FIG. 1.

FIG. 8 is a comparison diagram of a steady-state vibration amounts of the embodiment shown in FIG. 1 and a comparative example.

FIG. 9 is a schematic diagram of a partial structure of a linear motor according to an embodiment of the present disclosure.

Reference signs: 10-Linear motor, 1-Housing (101-Receiving space, 102-Shell, 103-Cover), 2-Vibrator assembly (201-Central magnet portion (2011-First magnet, 2012-Iron core, 2013-Second magnet), 202-Weight), 3-Stator assembly (301-Coil portion, 302-Auxiliary magnet portion (3021-First auxiliary magnet group (30211-First auxiliary magnet))), 4-Elastic assembly (401-Elastic sheet (4011-Elastic arm, 4012-First connecting arm, 4013-Second connecting arm), 402-First insert, 403-Second insert, 404-Third insert), 5-Circuit board.

### DESCRIPTION OF EMBODIMENTS

The present disclosure will be further described below in conjunction with the drawings and embodiments.

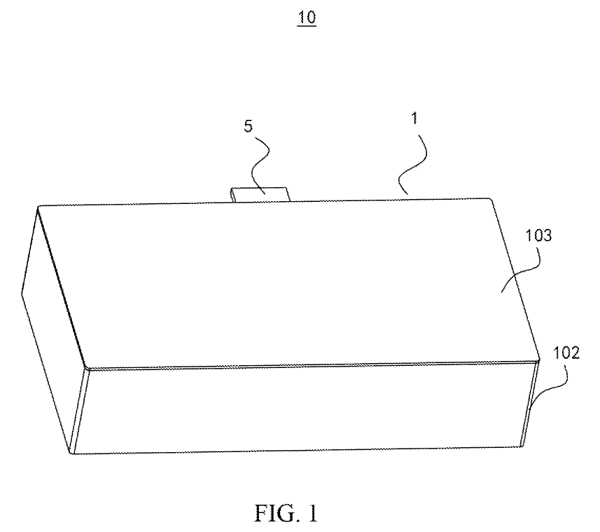

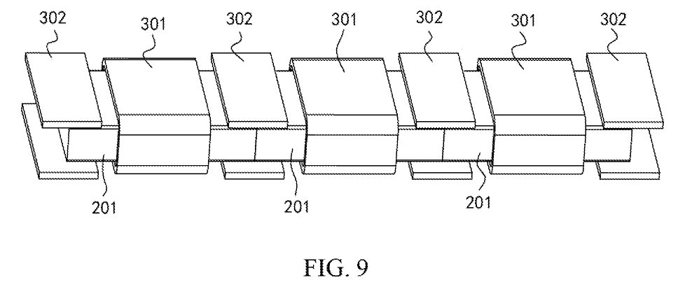

An embodiment of the present disclosure provides a linear motor 10, including a housing 1, an vibrator assembly 2, a stator assembly 3 and an elastic assembly 4, referring to FIG. 1 to FIG. 7, and FIG. 9. The housing 1 has a receiving space 101. In an embodiment, the stator assembly 3 is fixed in the receiving space 101, the vibrator assembly 2 is suspended in the receiving space 101, and the elastic assembly 4 is configured to suspend and support the vibrator assembly 2 in the receiving space 101. The vibrator assembly 2 includes a central magnet portion 201. The stator assembly 3 includes a coil portion 301 and auxiliary magnet portions 302. The coil portion 301 and the auxiliary magnet portions 302 are arranged along a first direction. The coil portion 301 is sleeved on a middle portion of an outer periphery of the central magnet portion 201, and two ends of the central magnet portion 201 are provided with the auxiliary magnet portions 302, respectively. The coil portion 301 pushes the vibrator assembly 2 to vibrate along the first direction after being energized, and the auxiliary magnet portions 302 and the elastic assembly 4 jointly provide a restoring force for the vibrator assembly 2, in such a manner that the vibrator assembly 2 reciprocates along the first direction.

In some embodiments, the first direction can be the X-axis.

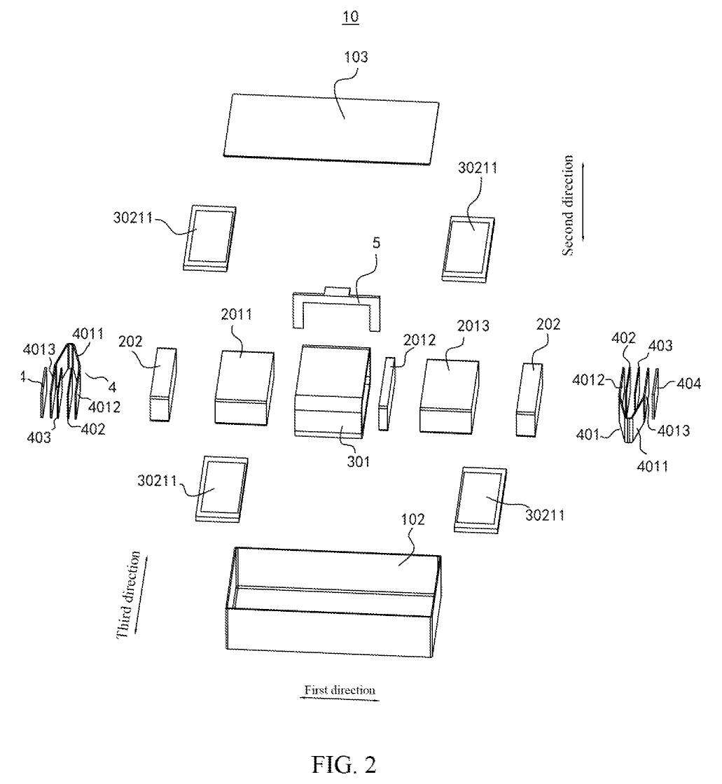

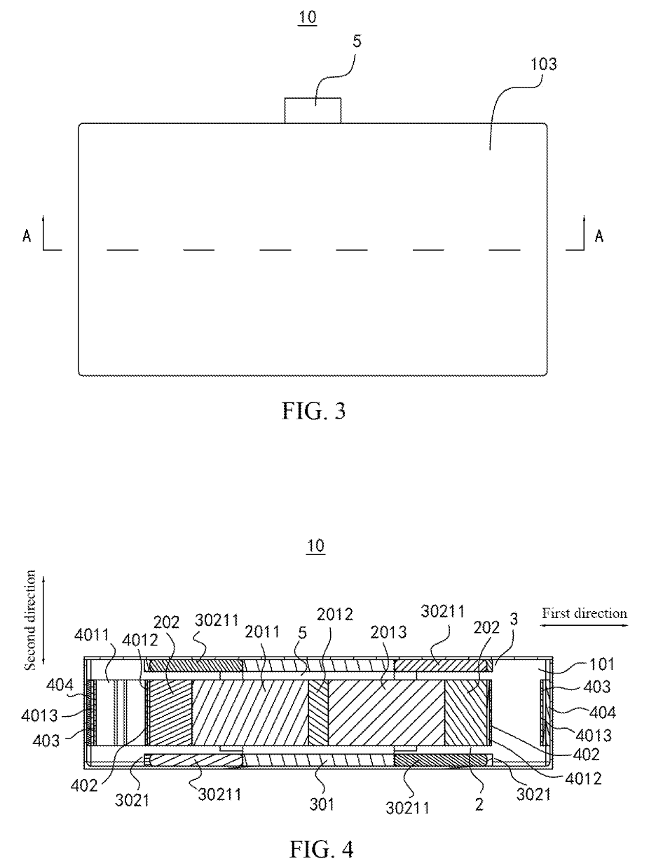

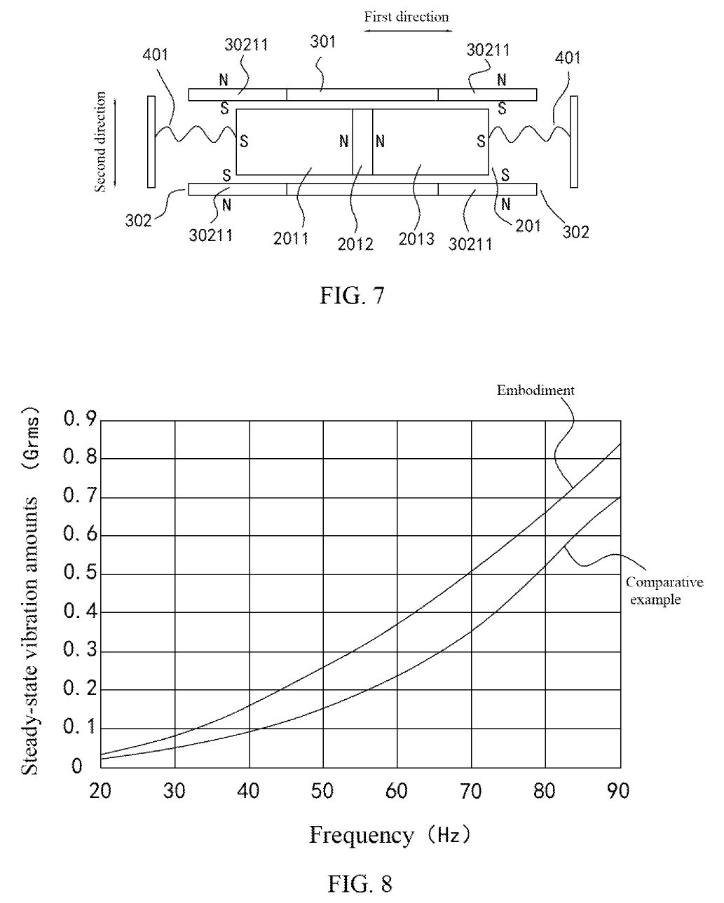

In some embodiments of the present disclosure, referring to FIG. 2, FIG. 4 and FIG. 7, the coil portion 301 can push the vibrator assembly 2 to vibrate along the first direction after being energized, and the auxiliary magnet portions 302 and the elastic assembly 4 jointly provide the restoring force for the vibrator assembly 2, in such a manner that the vibrator assembly 2 reciprocates along the first direction. The magnetic force generated by the interaction between the auxiliary magnet portions 302 and the central magnet portion 201 can increase the negative stiffness, thereby reducing the resonant frequency of the linear motor 10 and improving the low-frequency vibration. Meanwhile, the auxiliary magnet portions 302 do not affect the vibration path of the vibrator assembly 2 and do not occupy the design dimensions of the first direction, thus the size of the linear motor 10 will not be increased. Compared with traditional motors, a larger stroke can be designed to enhance the low-frequency vibration and improve the attenuation of the electromagnetic driving force under the large stroke, so that the motor has a more stable input performance within the stroke. In addition, it is not necessary to design the elastic assembly 4 to be softer in order to reduce the stiffness of the motor system, and the process and thickness requirements for the elastic component 4 can be relaxed to improve the overall stability and reliability of the motor. Moreover, the negative stiffness of the motor system can be adjusted by controlling the size and magnetism of the auxiliary magnet portions 302. The auxiliary magnet portions 302 have a simple structure, are easy to process, and have a low cost, which can effectively control the production cost.

As an example, referring to FIG. 7, in the initial state, the magnetic circuit resulting force of the linear motor 10 is zero, and the vibrator assembly 2 maintains balance and is located at the center. The coil portion 301 pushes the vibrator assembly 2 to swing along the first direction after being energized, and the magnetic resistance between the auxiliary magnet portions 302 and the central magnet portion 201 changes. The magnetic forces of the two auxiliary magnet portions 302 on the central magnet portion 201 are unbalanced, and the magnetic force of the auxiliary magnet portion 302 on one side increases, while the magnetic force of the auxiliary magnet portion 302 on the other side decreases. Therefore, after the central magnet portion 201 deviates from the center position along the first direction, an unbalanced magnetic force F is generated along the first direction. By controlling the position and size of the auxiliary magnet portions 302, the magnetic force F can be changed linearly with the deviation from the center position. Referring to FIG. 8, the low-frequency vibration of the linear motor 10 according to the embodiment of the present disclosure is significantly improved compared to the low-frequency vibration of the conventional motor of the comparative example.

In some optional embodiments, referring to FIG. 2, FIG. 4 and FIG. 7, the central magnet portion 201 includes a first magnet 2011, an iron core 2012 and a second magnet 2013. The first magnet 2011, the iron core 2012 and the second magnet 2013 are sequentially arranged along the first direction, and the first magnet 2011 and the second magnet 2013 are symmetrically arranged on two sides of the iron core 2012. The first magnet 2011 and the second magnet 2013 generate a magnetic field. The coil portion 301 after being energized generates a driving force in the magnetic field to drive the vibrator assembly 2 to vibrate along the first direction. The iron core 2012 can enhance the magnetic field to make the driving force greater.

In some embodiment, the first magnet 2011 can be a permanent magnet, and the second magnet 2013 can also be a permanent magnet.

It can be understood that, in the initial state, referring to FIG. 4 and FIG. 7, the coil portion 301 is arranged in an axisymmetric manner with respect to the iron core 2012, which can maximize the use of the magnetic field and generate a greater driving force.

In some embodiment, the iron core 2012 can also be replaced with a structure made of other materials that can enhance the magnetic field.

In some optional embodiments, referring to FIG. 7, the first magnet 2011 and the second magnet 2013 are magnetized along a first direction, and magnetic poles of the first magnet 2011 and the second magnet 2013 are arranged opposite to each other with same polarity, thereby generating a strong magnetic field.

In some embodiments, referring to FIG. 7, the first magnet 2011 and the second magnet 2013 are magnetized along a first direction, N pole of the first magnet 2011 is arranged opposite to N pole of the second magnet 2013, and the magnetic poles of the first magnet 2011 and the second magnet 2013 are arranged opposite to each other with the same polarity, thereby generating a strong magnetic field.

It can be understood that, in some embodiments, S pole of the first magnet 2011 can also be arranged opposite to S pole of the second magnet 2013, and magnetic poles of the auxiliary magnet portions 302 can also be changed accordingly, which will not be elaborated in the present disclosure.

In some optional embodiments, one of the auxiliary magnet portions 302 include first auxiliary magnet groups 3021 and/or second auxiliary magnet groups. One of the first auxiliary magnet groups 3021 includes two first auxiliary magnets 30211, the two first auxiliary magnets 30211 are arranged at intervals along a second direction, and the two first auxiliary magnets 30211 are arranged on two sides of the end of the central magnet portion 201, respectively. One of the second auxiliary magnet groups includes two second auxiliary magnets, the two second auxiliary magnets are arranged at intervals along a third direction, and the two second auxiliary magnets are arranged on two sides of the end of the central magnet portion 201, respectively. The first direction, the second direction and the third direction are arranged perpendicularly to each other. The specific structure of the auxiliary magnet portions 302 can be determined according to the required negative stiffness.

In some embodiments, referring to FIG. 2, FIG. 4, FIG. 7 and FIG. 9, one of the auxiliary magnet portions 302 can include the first auxiliary magnet groups 3021. One of the first auxiliary magnet groups 3021 includes the two first auxiliary magnets 30211, the two first auxiliary magnets 30211 are arranged along the second direction, and the two first auxiliary magnets 30211 are arranged on two sides of the end of the central magnet portion 201, respectively.

It can be understood that, in some embodiments, one of the auxiliary magnet portions 302 can include second auxiliary magnet groups. One of the second auxiliary magnet groups includes two second auxiliary magnets, the two second auxiliary magnets are arranged along the third direction, and the two second auxiliary magnets are arranged on two sides of the end of the central magnet portion 201, respectively. Alternatively, in some embodiment, one of the auxiliary magnet portions 302 can simultaneously include the first auxiliary magnet groups 3021 and the second auxiliary magnet groups. The specific structure of the auxiliary magnet portions 302 can be determined according to the required negative stiffness, which will not be elaborated in the present disclosure.

In some embodiments, referring to FIG. 7, the two first auxiliary magnets 30211 of the first auxiliary magnet group 3021 are magnetized along the second direction, respectively, and the magnetic poles of the two first auxiliary magnets 30211 are arranged opposite to each other with the same polarity. Meanwhile, the two first auxiliary magnets 30211 are also arranged opposite to the central magnet portion 201 in a manner that the magnetic poles of same polarity repel each other, a repulsive force is generated by the principle of same poles repulsion, and a magnetic spring system is formed, so that the auxiliary magnet portions 302 and the elastic assembly 4 can jointly provide the restoring force for the vibrator assembly 2, which causes the vibrator assembly 2 to reciprocate along the first direction. Moreover, the magnetic force generated by the interaction between the auxiliary magnet portions 302 and the central magnet portion 201 can increase the negative stiffness, thereby reducing the resonant frequency of the linear motor 10 and improving the low-frequency vibration.

In some embodiments, referring to FIG. 7, the first magnet 2011 and the second magnet 2013 are magnetized along the first direction, the N pole of the first magnet 2011 is arranged opposite to the N pole of the second magnetic steel 2013, and the magnetic poles of the first magnet 2011 and the second magnet 2013 are arranged opposite to each other with the same polarity, thereby generating a strong magnetic field. The two auxiliary magnet portions 302, totaling four first auxiliary magnets 30211, are magnetized along the second direction, respectively. The S poles of the two first auxiliary magnets 30211 of one of the two auxiliary magnet portions 302 are arranged opposite to the S pole of the first magnet 2011, respectively, and the S poles of the two first auxiliary magnets 30211 of the other of the two auxiliary magnet portions 302 are arranged opposite to the S pole of the second magnet 2013, respectively. A repulsive force is generated by the principle of same poles repulsion, and a magnetic spring system is formed, so that the auxiliary magnet portions 302 and the elastic assembly 4 can jointly provide the restoring force for the vibrator assembly 2, which causes the vibrator assembly 2 to reciprocate along the first direction. Moreover, the magnetic force generated by the interaction between the auxiliary magnet portions 302 and the central magnet portion 201 can increase the negative stiffness, thereby reducing the resonant frequency of the linear motor 10 and improving the low-frequency vibration.

In some embodiments, the two second auxiliary magnets of the second auxiliary magnet group are magnetized along the third direction, and the magnetic poles of the two second auxiliary magnets are arranged opposite to each other with the same polarity. Meanwhile, the two second auxiliary magnets are also arranged opposite to the central magnet portion 201 in a manner that the magnetic poles of same polarity repel each other, a repulsive force is generated by the principle of same poles repulsion, and a magnetic spring system is formed, so that the auxiliary magnet portions 302 and the elastic assembly 4 can jointly provide the restoring force for the vibrator assembly 2, which causes the vibrator assembly 2 to reciprocate along the first direction. Moreover, the magnetic force generated by the interaction between the auxiliary magnet portions 302 and the central magnet portion 201 can increase the negative stiffness, thereby reducing the resonant frequency of the linear motor 10 and improving the low-frequency vibration.

In some embodiments, the first auxiliary magnet 30211 can be a permanent magnet, and the second auxiliary magnet can also be a permanent magnet.

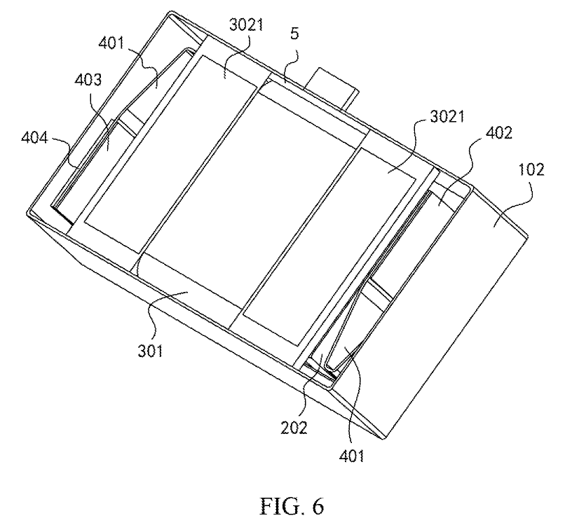

In some optional embodiments, referring to FIG. 2, FIG. 4 and FIG. 6, the vibrator assembly 2 further includes weights 202. The weights 202 can be fixed to both ends of the central magnet portion 201 along the first direction, and each of the weights 202 is connected to the elastic assembly 4, respectively. In this embodiment, the weights 202 can provide a greater vibration amount to the vibrator assembly 2.

In some embodiment, as shown in FIG. 2 and FIG. 4, the vibrator assembly 2 can include two weights 202, and the two weights 202 are arranged along the first direction. One of the two weights 202 is fixed to one end of the central magnet portion 201, and the other of the two weights 202 is fixed to the other end of the central magnet portion 201. Moreover, the two weights 202 can be arranged in an axisymmetric manner with respect to the central magnetic steel portion 201, so that the overall structure is more stable.

It can be understood that, in some embodiments, the vibrator assembly 2 may not include the weights 202, which depends on actual needs.

In some optional embodiments, referring to FIG. 2, and FIG. 4 to FIG. 7, the elastic assembly 4 includes two elastic sheets 401, and the two elastic sheets 401 are arranged along the first direction. One of the elastic sheets 401 is arranged between one end of the vibrator assembly 2 and the housing 1, and the other of the elastic sheets 401 is arranged between the other end of the vibrator assembly 2 and the housing 1. The two elastic sheets 401 are V-shaped structures, and opening ends of the two elastic sheets 401 are arranged in opposite directions. In this embodiment, the elastic sheets 401 provides spring stiffness, and the magnetic force generated by the auxiliary magnet portions 302 on the central magnet portion 201 of the vibrator assembly 2 can be used to increase negative stiffness of the system. Moreover, since the auxiliary magnet portions 302 are provided, there is no need to make a soft elastic sheet 401 in order to increase the negative stiffness, and the process and thickness requirements for the elastic sheets 401 can be relaxed to improve the overall stability and reliability of the motor. Within the allowable range of the stability and reliability of the elastic sheets 401, the motor stroke can be appropriately increased to enhance the low-frequency vibration.

In some optional embodiment, referring to FIG. 2, one of the elastic sheets 401 includes an elastic arm 4011, a first connecting arm 4012 and a second connecting arm 4013. The first connecting arm 4012 and the second connecting arm 4013 are formed by extending from both ends of the elastic arm 4011, respectively. In an embodiment, the first connecting arm 4012 is configured to connect to the vibrator assembly 2, and the second connecting arm 4013 is configured to connect to the housing 1.

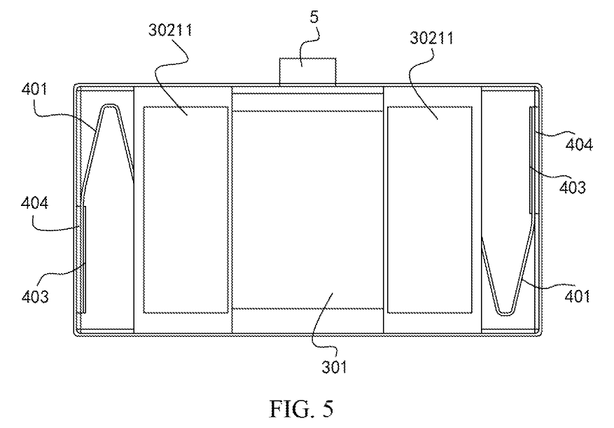

In some embodiments, referring to FIG. 2, FIG. 5 and FIG. 6, in order to protect the elastic sheets 401, the elastic assembly 4 can further include a first insert 402, a second insert 403 and a third insert 404. In an embodiment, the first insert 402 is fixed to a side of the first connecting arm 4012 away from the vibrator assembly 2, the second insert 403 is fixed to a side of the second connecting arm 4013 away from the housing 1, and the third insert 404 is fixed to a side of the second connecting arm 4013 close to the housing 1, thereby preventing the first connecting arm 4012 and the second connecting arm 4013 form stress deformation.

In some embodiments, the first insert 402, the second insert 403 and the third insert 404 can have overlapping projections along the first direction, and the projections of the first insert 402, the second insert 403 and the third insert 404 along the first direction can at least partially overlap, or even completely overlap, with the projections of the first connecting arm 4012 and the second connecting arm 4013 along the first direction, thereby more fully protecting the elastic sheets 401.

In some optional embodiments, referring to FIG. 1 to FIG. 3, FIG. 5 and FIG. 6, the linear motor 10 further includes a circuit board (PCB) 5. The circuit board 5 is electrically connected to the coil portion 301, and can provide alternating current to the coil portion 301. Moreover, in order to protect the circuit board 5 and make the overall structure more stable, the circuit board 5 can be at least partially received in the receiving space 101.

As an example, the circuit board 5 can be a FPC (Flexible Printed Circuit) for easier assembly.

In some optional embodiments, referring to FIG. 2 and FIG. 9, the linear motor further includes one or more central magnet portions 201. A number of the coil portions 301 is equal to a number of the central magnet portions 201, and the coil portions 301 are arranged in a one-to-one correspondence with the central magnet portions 201. Referring to FIG. 9, in response to the fact that the linear motor includes a plurality of the central magnet portions 201, the central magnet portions 201 are sequentially fixed into a whole along the first direction. The auxiliary magnet portions 302 correspond to the ends where two adjacent central magnet portions 201 are connected. That is, the central magnet portions 201 can be stacked, and the auxiliary magnet portions 302 can be changed accordingly for stacking.

In some embodiments, referring to FIG. 2, and FIG. 4 to FIG. 7, the linear motor 10 includes a central magnet portion 201, a coil portion 301 and two auxiliary magnet portions 302.

In some embodiments, referring to FIG. 9, the linear motor 10 includes a plurality of central magnet portions 201, a plurality of coil portions 301 and a plurality of auxiliary magnet portions 302. In an embodiment, the number of the coil portions 301 is equal to the number of the central magnet portions 201, and the coil portions 301 are arranged in a manner that one coil portion 301 corresponds to one central magnet portion 201. All the central magnet portions 201 are sequentially connected end-to-end along the first direction and fixed into a whole. One of the auxiliary magnet portions 302 is arranged corresponding to a head end of a central magnet portion 302 located at a head of the whole, one of the auxiliary magnet portions 302 is arranged corresponding to a tail end of a central magnet portion 302 located at a tail of the whole, and remaining auxiliary magnet portions 302 correspond to connected ends of two adjacent central magnet portions 201.

In some optional embodiments, referring to FIG. 1 to FIG. 4, for easy assembly, the housing 1 includes a shell 102 and a cover 103 covering the shell 102, and the shell 102 and the cover 103 jointly form the receiving space 101.

The linear motor 10 according to the embodiments of the present disclosure can be applied to fields such as watches, mobile phones, handhelds, handles, AR (Augmented Reality), VR (Virtual Reality), and vehicle-mounted technology.

The above description is only implementations of the present disclosure. It should be pointed out that, for those skilled in the art, improvements can be made without departing from the inventive concept of the present disclosure, but all of them fall within the protection scope of the present disclosure.

What is claimed is:

1. A linear motor, comprising a housing with a receiving space, and a vibrator assembly, a stator assembly and an elastic assembly received in the receiving space,
wherein the elastic assembly is configured to suspend and support the vibrator assembly in the receiving space;
wherein the vibrator assembly comprises a central magnet portion; the stator assembly comprises a coil portion and auxiliary magnet portions that are arranged along a first direction, the coil portion is sleeved on a middle portion of an outer periphery of the central magnet portion, two ends of the central magnet portion are provided with the auxiliary magnet portions, respectively, the coil portion, when energized, drives the vibrator assembly to vibrate along the first direction, and the auxiliary magnet portions and the elastic assembly jointly provide a restoring force for the vibrator assembly to reciprocate along the first direction; and
wherein one of the auxiliary magnet portions comprises a first auxiliary magnet group and/or a second auxiliary magnet group, the first auxiliary magnet group comprises two first auxiliary magnets arranged along a second direction and provided on two sides of each end of the central magnet portion, respectively; the second auxiliary magnet group comprises two second auxiliary magnets arranged along a third direction and provided on two sides of each end of the central magnet portion, respectively;
wherein the first direction, the second direction and the third direction are arranged perpendicularly to one another.

2. The linear motor as described in claim 1, wherein
the central magnet portion comprises a first magnet, an iron core, and a second magnet that are arranged along the first direction; and
the first magnet and the second magnet are symmetrically arranged on two sides of the iron core.

3. The linear motor as described in claim 2, wherein
the first magnet and the second magnet are magnetized along the first direction and magnetic poles with same polarity are arranged opposite to each other.

4. The linear motor as described in claim 1, wherein
the two first auxiliary magnets are magnetized along the second direction and magnetic poles with same polarity are arranged opposite to each other, and
the two second auxiliary magnets are magnetized along the third direction and magnetic poles with same polarity are arranged opposite to each other,
wherein magnetic poles of a polarity of the first auxiliary magnet and the second auxiliary magnet are arranged opposite to a magnetic pole of the same polarity of the central magnet portion, respectively.

5. The linear motor as described in claim 1, wherein
the vibrator assembly further comprises weights fixed to both ends of the central magnet portion along the first direction, and each of the weights is connected to the elastic assembly, respectively.

6. The linear motor as described in claim 1, wherein
the elastic assembly comprises two elastic sheets arranged along the first direction, one of the elastic sheets is arranged between one end of the vibrator assembly and the housing, and the other of the two elastic sheets is arranged between the other end of the vibrator assembly and the housing,
wherein the two elastic sheets have V-shaped structures, and opening ends of the two elastic sheets are arranged in opposite directions.

7. The linear motor as described in claim 6, wherein
each elastic sheet of the two elastic sheets comprises an elastic arm, and a first connecting arm and a second connecting arm that extend from the elastic arm, respectively,
wherein the first connecting arm is configured to connect to the vibrator assembly, and the second connecting arm is configured to connect to the housing, and the elastic assembly further comprises a first insert, a second insert and a third insert that are fixed to the elastic sheet and overlap in projection along the first direction;
wherein the first insert is fixed to a side of the first connecting arm away from the vibrator assembly, the second insert is fixed to a side of the second connecting arm away from the housing, and the third insert is fixed to a side of the second connecting arm adjacent to the housing.

8. The linear motor as described in claim 1, further comprising a circuit board at least partially received in the receiving space, wherein the circuit board is electrically connected to the coil portion.

9. The linear motor as described in claim 1, further comprising one or more central magnet portions and one or more coil portions; wherein number of the coil portions is equal to number of the central magnet portions, and the coil portions are arranged in a one-to-one correspondence with the central magnet portions;
wherein in case that the linear motor comprises a plurality of the central magnet portions, the plurality of central magnet portions is sequentially connected end-to-end along the first direction and fixed into a whole central magnet portion;
wherein one of the auxiliary magnet portions is arranged corresponding to a head end of a central magnet portion located at a head of the whole central magnet portion, one of the auxiliary magnet portions is arranged corresponding to a tail end of a central magnet portion located at a tail of the whole central magnet portion, and remaining auxiliary magnet portions correspond to connected ends of two adjacent central magnet portions.
